(19) United States
(12) Patent Application Publication
(10) Pub. No.: US 2026/0253553 A1
(43) Pub. Date: Aug. 27, 2026

(54) GATE DRIVING CIRCUIT AND DISPLAY DEVICE

(71) Applicant: LG Display Co., Ltd., Seoul (KR)

(72) Inventor: SeungHo HEO, Paju-si (KR)

(73) Assignee: LG Display Co., Ltd., Seoul (KR)

(21) Appl. No.: 19/422,069

(22) Filed: Dec. 16, 2025

(30) Foreign Application Priority Data
Feb. 24, 2025 (KR) 10-2025-0023857

(51) Int. Cl. G09G 3/3266; G09G 3/32; G09G 3/3291

(52) U.S. Cl. CPC G09G 3/3266; G09G 3/32; G09G 3/3291; G09G 2300/0465; G09G 2310/0267; G09G 2310/0275; G09G 2320/043

(57) ABSTRACT

A display device can include a display panel having a plurality of sub-pixels configured to display an image, a gate driving circuit configured to drive a plurality of gate lines, and a data driving circuit configured to supply a data voltage to a plurality of data lines. At least one of the plurality of sub-pixels is electrically connected to at least one sub-pixel connected to the same data line among adjacent sub-pixels through a second emission control transistor, thereby allowing data to be shared between the sub-pixels.

### CROSS-REFERENCE TO RELATED APPLICATION

This application claims priority to Korean Patent Application No. 10-2025-0023857, filed in the Republic of Korea on Feb. 24, 2025, which is hereby incorporated by reference for all purposes as if fully set forth herein.

### BACKGROUND

### Field

Embodiments of the present disclosure relate to a gate driving circuit and a display device with the gate driving circuit.

### Discussion of the Related Art

A display device for displaying images can include a liquid crystal display (LCD) using liquid crystals and an organic light-emitting display (OLED) using organic light-emitting diodes.

In an organic light-emitting display, a plurality of sub-pixels, each including an organic light-emitting diode and a driving transistor for driving the organic light-emitting diode, are arranged in a matrix format. The brightness of the sub-pixels selected by a scan gate signal can be controlled according to the grayscale of the data.

In the organic light-emitting display, each sub-pixel defined on a display panel can be configured with the organic light-emitting diode and the driving transistor for driving the organic light-emitting diode. The characteristics of each sub-pixel (e.g., threshold voltage, mobility, etc.) can vary depending on the driving time, or there can be characteristic deviations between the sub-pixels due to differences in the driving time of each driving transistor. This can result in luminance deviations between sub-pixels, i.e., luminance unevenness, which can degrade image quality.

Accordingly, in the organic light-emitting display devices, there can be performed a process of sensing and compensating for the characteristic deviation between sub-pixels in order to minimize the luminance deviation between sub-pixels.

In the organic light-emitting display devices, during the process of sensing the characteristic value for a target sub-pixel among the plurality of sub-pixels, there can occur a horizontal line dimming phenomenon in which a row (i.e., a horizontal line) including the target sub-pixel is processed as black. This horizontal line dimming phenomenon can cause a deterioration in display quality, and efforts are ongoing to solve this limitation.

### SUMMARY OF THE DISCLOSURE

Embodiments of the present disclosure can provide a gate driving circuit and a display device capable of reducing the horizontal line dimming phenomenon by sharing data between adjacent sub-pixels through switching operation of transistors arranged between at least two adjacent sub-pixels.

Embodiments of the present disclosure can provide a gate driving circuit and a display device capable of activating a light emitting device even when sensing a characteristic value by optimizing the arrangement of switching elements provided in each of the plurality of sub-pixels.

Embodiments of the present disclosure can provide a gate driving circuit and a display device capable of supplying an emission control gate signal using a smaller number of transistors by optimizing the structure of an emission control driver, thereby reducing manufacturing costs, securing space margins, and reducing the weight of a device.

The objects of the embodiments of the present disclosure are not limited to the objects described in this specification, and other objects will be clearly understood by those skilled in the art from the description below.

A display device according to embodiments of the present disclosure can include a display panel in which a plurality of sub-pixels each of which having a driving transistor, a light emitting device, and a first emission control transistor disposed between the driving transistor and the light emitting device, a plurality of gate lines, and a plurality of data lines are disposed, a gate driving circuit configured to drive the plurality of gate lines, and a data driving circuit configured to supply a data voltage to the plurality of data lines. In this case, at least one of the plurality of sub-pixels can be electrically connected to at least one adjacent sub-pixel connected to the same data line through a second emission control transistor. In addition, the first emission control transistor can be disposed between a first node to which the driving transistor is electrically connected and a second node to which the second emission control transistor and the light emitting device are electrically connected.

A gate driving circuit according to embodiments of the present disclosure can include a scan driver that supplies a scan gate signal to a second sub-pixel adjacent to a first sub-pixel, connected to the same data line as the first sub-pixel, and electrically connected to the first sub-pixel through a second emission control transistor; a second emission control driver that supplies a second emission control gate signal to a gate node of the second emission control transistor; and a first emission control driver that supplies a first emission control gate signal corresponding to the second emission control gate signal to a first emission control transistor disposed in the second sub-pixel. In this case, the first emission control transistor can be disposed between a first node to which a driving transistor is electrically connected and a second node to which the second emission control transistor and a light emitting device are electrically connected, and can receive the second emission control gate signal through a gate node.

According to embodiments of the present disclosure, it is possible to provide a gate driving circuit and a display device capable of reducing or preventing the horizontal line dimming phenomenon by sharing data between adjacent sub-pixels through switching operation of transistors arranged between at least two adjacent sub-pixels.

According to embodiments of the present disclosure, it is possible to provide a gate driving circuit and a display device capable of activating a light emitting device even when sensing a characteristic value by optimizing the arrangement of switching elements provided in each of the plurality of sub-pixels.

According to embodiments of the present disclosure, it is possible to provide a gate driving circuit and a display device capable of supplying an emission control gate signal using a smaller number of transistors by optimizing the structure of an emission control driver, thereby reducing or minimizing manufacturing costs, securing space margins, and reducing/minimizing the weight of a device.

The effects of the embodiments of the present disclosure are not limited to the effects described as above, and other effects will be clearly understood by those skilled in the art from the claims.

### BRIEF DESCRIPTION OF THE DRAWINGS

The present disclosure will be more fully understood from the detailed description and accompanying drawings provided below, which are provided for illustration purposes only and are not intended to limit the present disclosure.

FIG. 1 is a diagram for explaining a display device according to embodiments of the present disclosure.

FIGS. 2A and 2B illustrate examples of sub-pixels according to embodiments of the present disclosure.

FIG. 3 is a diagram further illustrating an example of the operation of a sub-pixel according to embodiments of the present disclosure.

FIG. 4 is a diagram illustrating an example of a gate driving circuit according to embodiments of the present disclosure.

FIGS. 5 and 6 are diagrams illustrating an example of drivers within a gate driving circuit according to embodiments of the present disclosure.

FIG. 7 is a diagram illustrating another example of drivers within a gate driving circuit according to embodiments of the present disclosure.

### DETAILED DESCRIPTION OF THE EMBODIMENTS

In the following description of examples or embodiments of the present invention, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present invention, detailed descriptions of well-known functions and components incorporated herein will be omitted when it is determined that the description can make the subject matter in some embodiments of the present invention rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” can be used herein to describe elements of the present invention. Each of these terms is not used to define essence, order, sequence, or number of elements etc., but is used merely to distinguish the corresponding element from other elements.

When it is mentioned that a first element "is connected or coupled to", “contacts or overlaps” etc. a second element, it should be interpreted that, not only can the first element “be directly connected or coupled to” or “directly contact or overlap” the second element, but a third element can also be "interposed" between the first and second elements, or the first and second elements can "be connected or coupled to", “contact or overlap”, etc. each other via a fourth element. Here, the second element can be included in at least one of two or more elements that "are connected or coupled to", “contact or overlap”, etc. each other.

When time relative terms, such as "after," "subsequent to," "next," "before," and the like, are used to describe processes or operations of elements or configurations, or flows or steps in operating, processing, manufacturing methods, these terms can be used to describe non-consecutive or non-sequential processes or operations unless the term "directly" or "immediately" is used together.

In addition, when any dimensions, relative sizes etc. are mentioned, it should be considered that numerical values for an elements or features, or corresponding information (e.g., level, range, etc.) include a tolerance or error range that can be caused by various factors (e.g., process factors, internal or external impact, noise, etc.) even when a relevant description is not specified. Further, the term “can” fully encompasses all the meanings of the term “may” and vice versa.

Hereinafter, various embodiments of the present disclosure are described in detail with reference to the accompanying drawings. All the components of each display device/apparatus according to all embodiments of the present disclosure are operatively coupled and configured.

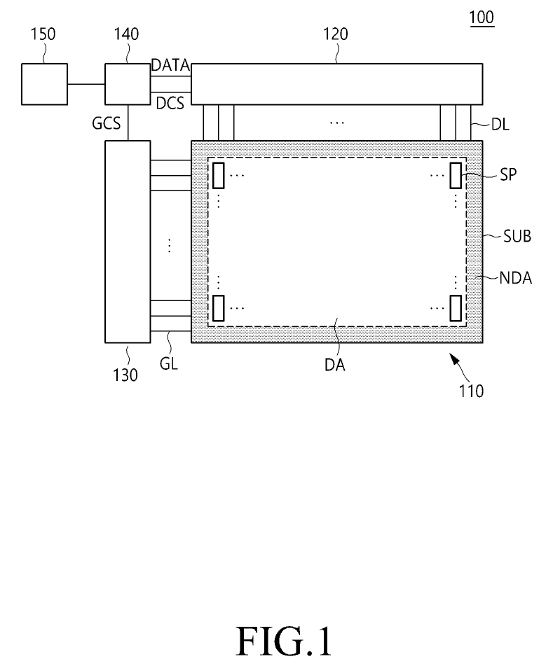

FIG. 1 is a diagram for explaining a display device 100 according to embodiments of the present disclosure.

Referring to FIG. 1, the display device 100 according to embodiments of the present disclosure can include a display panel 110 and a driving circuit for driving the display panel 110.

The driving circuit can include a data driving circuit 120 and a gate driving circuit 130, and can further include a controller 140 for controlling the data driving circuit 120 and the gate driving circuit 130.

The display panel 110 can include a substrate 111 and signal lines such as a plurality of data lines DL, a plurality of gate lines GL, and a plurality of sensing lines. The display panel 110 can include

a plurality of sub-pixels SP connected to the plurality of data lines DL, the plurality of gate lines GL, and the plurality of sensing lines.

The display panel 110 can include a display area DA where an image is displayed and a non-display area NDA located outside the display area DA where no image is displayed. The non-display area NDA can surround the display area entirely or only in part(s).

The plurality of sub-pixels SP for displaying an image can be arranged in the display area DA of the display panel 110. In the non-display area NDA, driving circuits 120, 130, and 140 can be electrically connected, or the driving circuits 120, 130, and 140 can be mounted, and a pad portion to which an integrated circuit or printed circuit is connected can be arranged.

The data driving circuit 120 can be connected to the plurality of data lines DL and the plurality of sensing lines.

The data driving circuit 120 is a circuit for driving the plurality of data lines DL, and can supply data signals to the plurality of data lines DL.

The gate driving circuit 130 is a circuit for driving the plurality of gate lines GL, and can supply gate signals to the plurality of gate lines GL.

The controller 140 can supply a data control signal DCS to the data driving circuit 120 to control the operation timing of the data driving circuit 120. The controller 140 can supply a gate control signal GCS to the gate driving circuit 130 to control the operation timing of the gate driving circuit 130.

The controller 140 can start scanning according to the timing implemented in each frame, can convert the input image data input from the outside to fit the data signal format used in the data driving circuit 120, and can supply converted image data Data to the data driving circuit 120 and control data driving at an appropriate time according to the scan timing.

The controller 140 can receive various timing signals including a vertical synchronization signal VSYNC, a horizontal synchronization signal HSYNC, an input data enable signal DE, a clock signal CLK in addition to the input image data from the outside (e.g., the host system 150).

In order to control the data driving circuit 120 and the gate driving circuit 130, the controller 140 can receive timing signals such as a vertical synchronization signal VSYNC, a horizontal synchronization signal HSYNC, an input data enable signal DE, and a clock signal CLK, and generate various control signals DCS and GCS and output to the data driving circuit 120 and the gate driving circuit 130.

For example, the controller 140 can output various gate control signals GCS including a gate start pulse GSP, a gate shift clock GSC, and a gate output enable signal GOE to control the gate driving circuit 130.

In addition, the controller 140 can output various data control signals DCS including a source start pulse SSP, a source sampling clock SSC, and a source output enable signal SOE to control the data driving circuit 120.

The controller 140 can be implemented as a separate component from the data driving circuit 120, or can be implemented as an integrated circuit integrated with the data driving circuit 120.

The data driving circuit 120 can receive image data DATA from the controller 140 and supply data voltage VDATA to a plurality of data lines DL, thereby driving a plurality of data lines DL. Here, the data driving circuit 120 is also referred to as a source driving circuit.

The data driving circuit 120 can include one or more source driver integrated circuits SDIC.

For example, each source driver integrated circuit SDIC can be connected to the display panel 110 using a tape automated bonding (TAB) method, or can be connected to the bonding pad of the display panel 110 using a chip-on-glass (COG) or chip-on-panel (COP) method, or can be implemented using a chip-on-film (COF) method and connected to the display panel 110.

The gate driving circuit 130 can output a gate signal of a turn-on voltage level or a gate signal of a turn-off voltage level under the control of the controller 140. The gate driving circuit 130 can sequentially drive a plurality of gate lines GL by sequentially supplying gate signals of a turn-on voltage level to a plurality of gate lines GL.

The gate driving circuit 130 can be connected to the display panel 110 using a tape automated bonding (TAB) method, or can be connected to a bonding pad of the display panel 110 using a chip-on-glass (COG) or chip-on-panel (COP) method, or can be connected to the display panel 110 according to a chip-on-film (COF) method. Alternatively, the gate driving circuit 130 can be a gate-in-panel (GIP) type, and can be formed in the non-display area NDA of the display panel 110. The gate driving circuit 130 can be disposed on or connected to the substrate SUB. For example, if the gate driving circuit 130 is of the GIP type, it can be disposed in the non-display area NDA of the substrate SUB. The gate driving circuit 130 can be connected to the substrate SUB in the case of a chip-on-glass (COG) type, chip-on-film (COF) type, etc.

Meanwhile, at least one of the data driving circuit 120 and the gate driving circuit 130 can be disposed in the display area DA. For example, at least one of the data driving circuit 120 and the gate driving circuit 130 can be disposed not to overlap with the sub-pixels SP, or can be disposed to partially or entirely overlap the sub-pixels SP.

If a specific gate line GL is opened by the gate driving circuit 130, the data driving circuit 120 can convert the image data DATA received from the controller 140 into an analog data voltage VDATA and supply the converted image data to a plurality of data lines DL.

The data driving circuit 120 can be connected to one side (e.g., the upper side or the lower side) of the display panel 110. Depending on the driving method and/or panel design method, the data driving circuit 120 can be connected to both sides (e.g., the upper side and the lower side) of the display panel 110, or can be connected to two or more sides among the four sides of the display panel 110.

The gate driving circuit 130 can be connected to one side (e.g., the left side or the right side) of the display panel 110. Depending on the driving method and/or panel design method, the gate driving circuit 130 can be connected to both sides (e.g., left and right) of the display panel 110, or can be connected to two or more sides among the four sides of the display panel 110.

The controller 140 can be a timing controller used in conventional display technology, or a control device that can perform other control functions in addition to the timing controller, or can be a control device other than the timing controller, or can be a circuit within the control device. The controller 140 can be implemented with various circuits or electronic components such as an integrated circuit (IC), a field programmable gate array (FPGA), an application specific integrated circuit (ASIC), or a processor.

The controller 140 can be mounted on a printed circuit board or a flexible printed circuit, and can be electrically connected to the data driving circuit 120 and the gate driving circuit 130 through the printed circuit board or the flexible printed circuit.

The display device 100 according to the embodiments of the present disclosure can be a display device including a backlight unit such as a liquid crystal display (LCD), or can be a self-luminous display device such as an organic light-emitting diode (OLED) display device, a quantum dot display device, or a micro light-emitting diode (LED) display device.

In the case that the display device 100 according to the embodiments of the present disclosure is an OLED display device, each sub-pixel SP can include an organic light emitting diode (OLED) that emits light by itself as a light emitting device. If the display device 100 according to the embodiments of the present disclosure is a quantum dot display device, each sub-pixel SP can include a light emitting device made of a quantum dot, which is a semiconductor crystal that emits light by itself. If the display device 100 according to the embodiments of the present disclosure is a micro LED display device, each sub-pixel SP can include a micro LED that emits light by itself and is made of an inorganic material as a light emitting device.

The display panel 110 according to the embodiments of the present disclosure can have a top emission structure or a bottom emission structure, and in some cases, can have a double-sided emission structure.

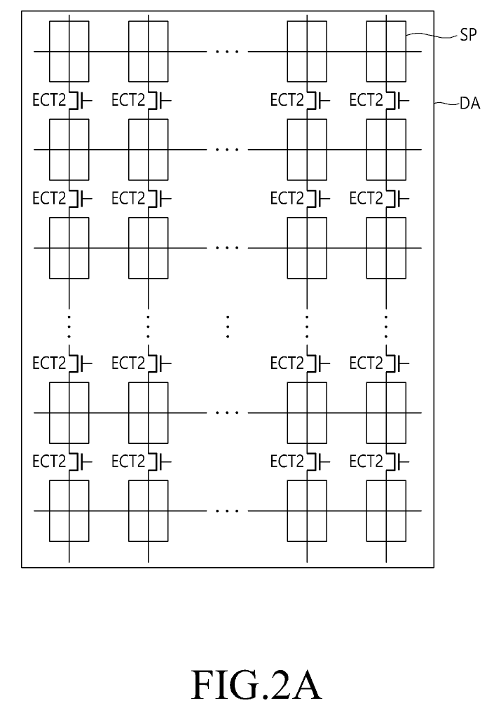

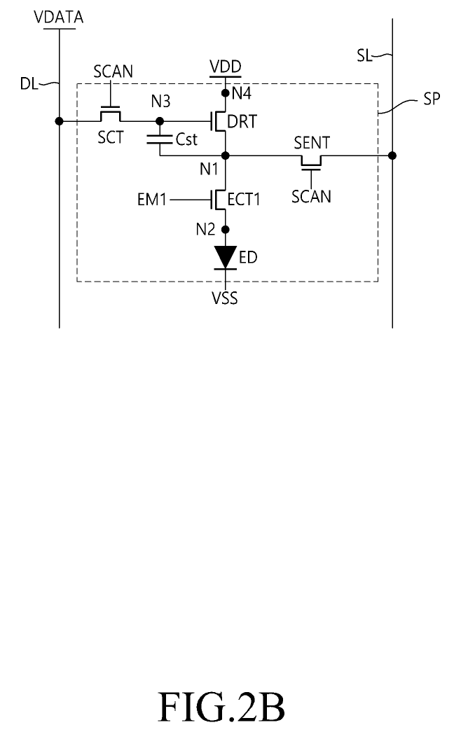

FIGS. 2A and 2B illustrate an example of a sub-pixel SP according to embodiments of the present disclosure.

Specifically, FIG. 2A illustrates an example of the arrangement of the plurality of sub-pixels SP in the display area DA within the display panel 110, and FIG. 2B illustrates a circuit diagram of a sub-pixel SP according to an example.

Referring to FIG. 2A, a display device 100 according to embodiments of the present disclosure can include a plurality of sub-pixels SP arranged at positions where n rows (where n is an integer greater than or equal to 1) and m columns (where m is an integer greater than or equal to 1) intersect in the display area DA. For example, the row direction can refer to a direction in which a gate line GL extends, and the column direction can refer to a direction in which a data line DL extends.

At least one of the plurality of sub-pixels SP can be electrically connected to at least one adjacent sub-pixel connected to the same data line DL among adjacent sub-pixels through a second emission control transistor ECT2.

According to the example of FIG. 2A, a second emission control transistor ECT2 can be disposed between sub-pixels arranged in the same column among the plurality of sub-pixels SP.

For example, assuming that the uppermost row in FIG. 2A can a first row and the bottommost row can be an n-th row, the second emission control transistor ECT2 can be disposed between a sub-pixel SP arranged in the first row and a sub-pixel SP arranged in the second row, and between a sub-pixel SP arranged in the second row and a sub-pixel SP arranged in a third row, in the same column.

Similarly, among the sub-pixels arranged in the same column, the second emission control transistor ECT2 can be disposed between a sub-pixel SP arranged in the (n-1)-th sub-pixel and a sub-pixel SP arranged in the n-th sub-pixel.

According to an embodiment of the present disclosure, a plurality of first dummy sub-pixels corresponding to each of the sub-pixels SP arranged in the first row can be arranged in an upper row of the first row, and a second emission control transistor ECT2 can be disposed between the first dummy sub-pixel and the sub-pixel SP arranged in the first row in the same column.

According to an embodiment of the present disclosure, a plurality of second dummy sub-pixels corresponding to each of the sub-pixels SP arranged in the n-th row can be arranged in a lower row of the n-th row. The second emission control transistor ECT2 can be disposed between the sub-pixel and the second dummy sub-pixel in the same column.

Referring to FIG. 2B, a sub-pixel SP according to embodiments of the present disclosure can include a light emitting device ED, a driving transistor DRT, a scan transistor SCT, a sensing transistor SENT, and a first emission control transistor ECT1.

The light emitting device ED can include a common electrode, a pixel electrode, and an emission layer positioned between the common electrode and the pixel electrode.

The pixel electrode of the light emitting device ED can be an electrode disposed for each sub-pixel SP, and the common electrode can be an electrode commonly disposed for all sub-pixels SP.

For example, the pixel electrode can be an anode and the common electrode can be a cathode. Alternatively, the pixel electrode can be a cathode and the common electrode can be an anode.

The common electrode of the light emitting device ED can be connected to a low-potential voltage line to which a low-potential power supply voltage VSS is supplied.

For example, the light emitting device ED can be an organic light-emitting diode (OLED), a light-emitting diode (LED), or a quantum dot light emitting device.

The driving transistor DRT can be connected to a first node N1, a third node N3, and a fourth node N4.

The first node N1 can be a source or drain node of the driving transistor DRT, and can be electrically connected to a drain node or a source node of the first emission control transistor ECT1.

The third node N3 can be a gate node of the driving transistor DRT and can be electrically connected to a source node or drain node of the scan transistor SCT.

The fourth node N4 can be a drain or source node of the driving transistor DRT and can be electrically connected to a high-potential voltage line supplying a high-potential power supply voltage VDD.

Each of the first sub-pixel SP1 and the second sub-pixel SP2 can further include a storage capacitor Cst disposed between the first node N1 and the third node N3.

A storage capacitor Cst can be charged with an amount of charge corresponding to a voltage difference between the two terminals, and can serve to maintain the voltage difference between the two terminals for a predetermined frame time, thereby allowing the corresponding sub-pixel SP to emit light for the predetermined frame time.

The storage capacitor Cst can be an external capacitor intentionally designed outside the driving transistor DRT, rather than a parasitic capacitor (e.g., Cgs, Cgd) that exists between the gate node and the source node (or drain node) of the driving transistor DRT.

The scan transistor SCT can be controlled by a scan gate signal SCAN, and can be disposed between the third node N3 and a data line DL.

Specifically, the scan transistor SCT can be turned on by the scan gate signal SCAN at a turn-on voltage level supplied from the gate line GL, thereby transmitting the data voltage VDATA supplied from the data line DL to the third node N3.

Here, if the scan transistor SCT is an n-type transistor, the turn-on voltage level of the scan gate signal SCAN can be a high voltage level. If the scan transistor SCT is a p-type transistor, the turn-on voltage level of the scan gate signal SCAN can be a low voltage level.

The sensing transistor SENT is controlled by the scan gate signal SCAN and can be arranged between the first node N1 and the sensing line SL.

Specifically, the sensing transistor SENT can be turned on by a gate signal having a turn-on voltage level supplied from the gate line GL, thereby controlling the connection between a sensing line SL and the first node N1.

Here, if the sensing transistor SENT is an n-type transistor, the turn-on voltage level of the scan gate signal SCAN can be a high level. If the sensing transistor SENT is a p-type transistor, the turn-on voltage level of the scan gate signal SCAN can be a low level.

The sensing transistor SENT can be turned on by the scan gate signal SCAN having a turn-on voltage level, and can transfer a reference voltage VREF supplied through the sensing line SL to the first node N1.

In addition, the sensing transistor SENT can be turned on by the scan gate signal SCAN having a turn-on voltage level, and can transfer a voltage of the first node N1 to the sensing line SL.

The function of the sensing transistor SENT transferring the voltage of the first node N1 to the sensing line SL can be used when driving to sense the characteristics of the sub-pixel SP (e.g., threshold voltage, mobility, etc.) of the driving transistor DRT. In this case, the voltage transmitted to the sensing line SL can be a voltage for calculating the characteristic value of the sub-pixel SP or a voltage reflecting the characteristic value of the sub-pixel SP.

According to the example of FIG. 2B, the scan transistor SCT and the sensing transistor SENT can be connected to the same gate line GL.

For example, a gate node of the scan transistor SCT and a gate node of the sensing transistor SENT within one sub-pixel SP can be connected to one gate line GL and can receive the same gate signal, i.e., a scan gate signal SCAN. In this case, the on-off timing of the scan transistor SCT within one sub-pixel SP and the on-off timing of the sensing transistor SENT can be identical.

However, embodiments of the present disclosure are not limited thereto, and the scan transistor SCT and the sensing transistor SENT within one sub-pixel SP can be connected to different gate lines GL.

In this case, the scan transistor SCT can receive a scan gate signal SCAN at a turn-on voltage level from a scan gate line, which is a type of gate line GL, to control the connection between the data line DL and the third node N3. In addition, the sensing transistor SENT can receive a sensing gate signal at a turn-on voltage level from a sensing gate line, which is a type of gate line GL, to control the connection between the sensing line SL and the first node N1.

For example, in the case that the scan transistor SCT and the sensing transistor SENT are connected to different gate lines GL, the scan gate signal SCAN and the sensing gate signal can be separate gate signals, and the on-off timing of the scan transistor SCT and the on-off timing of the sensing transistor SENT within one sub-pixel SP can be independent of each other. Accordingly, the on-off timing of the scan transistor SCT and the on-off timing of the sensing transistor SENT within one sub-pixel SP can be the same or different.

According to the examples of FIGS. 2A and 2B, the first emission control transistor ECT1 can be controlled by a first emission control gate signal EM1, and can be disposed between the first node N1 to which the driving transistor DRT is electrically connected and the second node N2 to which the second emission control transistor ECT2 and the light emitting device ED are electrically connected.

Specifically, the first emission control transistor ECT1 can be turned on by a first emission control gate signal EM1 having a turn-on voltage level supplied from the gate line GL, thereby electrically connecting the first node N1 and the second node N2.

Here, if the first emission control transistor ECT1 is an n-type transistor, the turn-on voltage level of the first emission control gate signal EM1 can be a high voltage level. If the first emission control transistor ECT1 is a p-type transistor, the turn-on voltage level of the first emission control gate signal EM1 can be a low voltage level.

The second emission control transistor ECT2 can be controlled by the second emission control gate signal EM2 and can be disposed between the second node N2 of the first sub-pixel SP1 and the second node N2 of the second sub-pixel SP2.

According to the examples of FIGS. 2A and 2B, each of the driving transistor DRT, the scan transistor SCT, the sensing transistor SENT, the first emission control transistor ECT1, and the second emission control transistor ECT2 can be an n-type transistor, but the embodiments of the present disclosure are not limited thereto. Alternatively, at least one of the driving transistor DRT, the scan transistor SCT, the sensing transistor SENT, the first emission control transistor ECT1, and the second emission control transistor ECT2 can be a p-type transistor.

The structure of the sub-pixel SP illustrated in FIG. 2B is only an example, and can be variously modified to include one or more additional transistors or one or more additional capacitors.

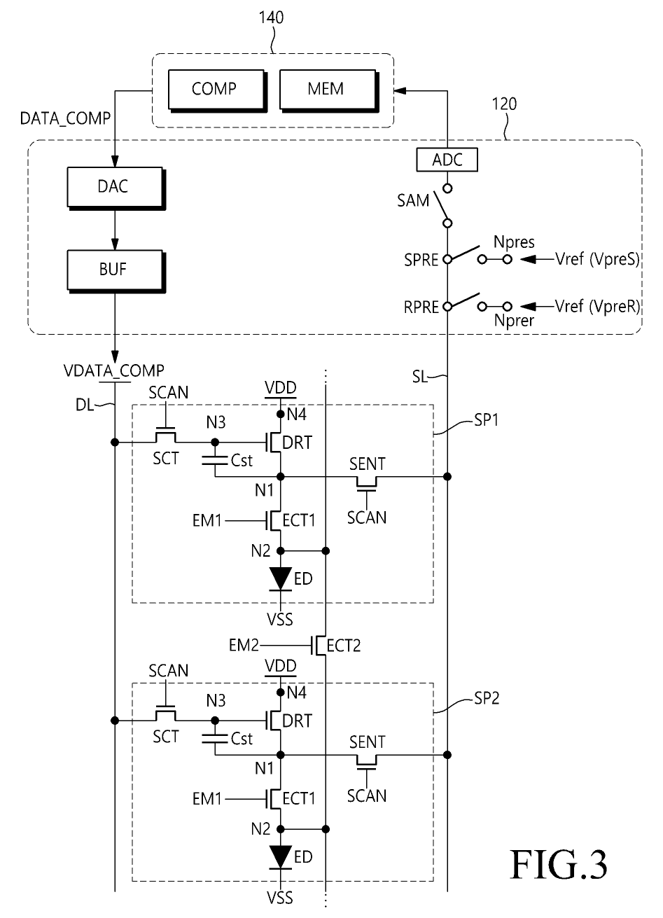

FIG. 3 is a drawing for further explaining an example of the operation of the sub-pixels (e.g., SP1, SP2) according to the embodiments of the present disclosure.

Referring to FIG. 3, the display device 100 according to embodiments of the present disclosure can compensate for the data voltage VDATA supplied to the sub-pixel SP based on a sensing voltage reflecting the characteristic value of the sub-pixel SP. To this end, the data driving circuit 120 can include at least one switching element (e.g., RPRE, SPRE, and SAM), an analog-to-digital converter ADC, a digital-to-analog converter DAC, and an output buffer BUF.

Among the at least one switching element (e.g., RPRE, SPRE, and SAM), a sensing reference switch SPRE is a switch that controls the driving of sensing the characteristic value, and can control the connection between the sensing line SL and a sensing reference voltage supply node Npres to which a reference voltage VREF is supplied. Here, the reference voltage VREF supplied to the sensing line SL by the sensing reference switch SPRE can be a sensing reference voltage VpreS.

Among at least one switching element (e.g., RPRE, SPRE, and SAM), a display driving reference switch RPRE is a switch used for driving the display, and can control the connection between the sensing line SL and a display driving reference voltage supply node Nprer to which a reference voltage VREF is supplied. Here, the reference voltage VREF supplied to the sensing line SL by the driving reference switch RPRE can be the display driving reference voltage VpreR.

For example, the sensing reference switch SPRE and the display driving reference switch RPRE can be provided separately, or can be implemented as one integrated unit, and the sensing reference voltage VpreS and the display driving reference voltage VpreR can be voltages having the same voltage level, or can be voltages having different voltage levels.

According to the example of FIG. 3, the plurality of sub-pixels SP can include a first sub-pixel SP1 and a second sub-pixel SP2 electrically connected to the first sub-pixel SP1 through a second emission control transistor ECT2.

Here, the first sub-pixel SP1 can refer to any one sub-pixel among the plurality of sub-pixels SP, and the second sub-pixel SP2 can refer to a sub-pixel disposed below the first sub-pixel SP1 in a plan view.

According to the example of FIG. 3, the second emission control transistor ECT2 can be disposed between a second node N2 of the first sub-pixel SP1 and a second node N2 of the second sub-pixel SP2.

The second node N2 of the first sub-pixel SP1 can be electrically connected not only to a second emission control transistor ECT2 disposed between the first sub-pixel SP1 and the second sub-pixel SP2, but also to a second emission control transistor ECT2 disposed between the first sub-pixel SP1 and a sub-pixel positioned above the first sub-pixel SP1.

Similarly, the second node N2 of the second sub-pixel SP2 can be electrically connected not only to a second emission control transistor ECT2 disposed between the first sub-pixel SP1 and the second sub-pixel SP2, but also to a second emission control transistor ECT2 disposed between the second sub-pixel SP2 and a sub-pixel positioned below the second sub-pixel SP2.

Hereinafter, for convenience of explanation, a process of sensing and compensating for the characteristics of the second sub-pixel SP2 is illustrated as an operation example of the sub-pixel SP according to embodiments of the present disclosure, however, the embodiments of the present disclosure are not limited thereto.

In the display device 100 according to embodiments of the present disclosure, during a sensing period of the second sub-pixel SP2, the first sub-pixel SP1 can be in a emission period in which the light emitting device ED disposed in the first sub-pixel SP1 emits light. Here, the sensing period can also be referred to as a blanking period.

Specifically, during the sensing period of the second sub-pixel SP2, a scan gate signal SCAN at a turn-off voltage level can be supplied to the first sub-pixel SP1, and a first emission control gate signal EM1 at a turn-on voltage level can be supplied to the first sub-pixel SP1.

Accordingly, the scan transistor SCT and the sensing transistor SENT disposed in the first sub-pixel SP1 are turned off, and the first emission control transistor EM1 is turned on, so that the light emitting device ED disposed in the first sub-pixel SP1 can emit light.

During the sensing period of the second sub-pixel SP2, a scan gate signal SCAN at a turn-on voltage level can be supplied to the second sub-pixel SP2, and a first emission control gate signal EM1 at a turn-off voltage level can be supplied to the second sub-pixel SP2.

Accordingly, the scan transistor SCT and the sensing transistor SENT disposed in the second sub-pixel SP2 are turned on, and the first emission control transistor EM1 is turned off, so that the sensing voltage reflecting the characteristic value of the second sub-pixel SP2, i.e., a voltage of the first node N1 of the second sub-pixel SP2, can be transmitted to the sensing line SL.

If the sensing voltage reflecting the characteristic value of the second sub-pixel SP2 is transmitted from the sensing line SL, the data driving circuit 120 can control a sampling switch SAM that controls the connection between the sensing line SL and the analog-to-digital converter ADC, so that the sensing voltage reflecting the characteristic value of the second sub-pixel SP2 can be transmitted to the analog-to-digital converter ADC.

The data driving circuit 120 can convert the sensing voltage reflecting the characteristic value of the second sub-pixel SP2 into a digital sensing value using an analog-to-digital converter ADC and output the digital sensing value to the controller 140.

The controller 140 can calculate a sensing result of the characteristic value for the second sub-pixel SP2 based on the digital sensing value received from the analog-to-digital converter ADC. To this end, the controller can include a memory MEM and a compensator COMP.

The memory MEM can store at least one preset reference data. In some embodiments, the memory MEM can also store a digital sensing value received from the analog-to-digital converter ADC.

The compensator COMP can compare the reference data stored in the memory MEM with the digital sensing value received from the analog-to-digital converter ADC, calculate compensation data DATA_COMP as a sensing result of the characteristic value, and feed back the calculated compensation data DATA_COMP to the data driving circuit 120.

The data driving circuit 120 can convert the compensation data DATA_COMP into a compensation data voltage VDATA_COMP in the form of an analog signal through a digital-to-analog converter DAC, and output the converted compensation data voltage VDATA_COMP to the corresponding data line DL through the output buffer BUF. Through this, the characteristic value deviation (i.e., threshold voltage deviation, mobility deviation) of the second sub-pixel SP2 can be compensated.

Meanwhile, during the sensing period of the second sub-pixel SP2, the scan gate signal SCAN having the same turn-on voltage level as the second sub-pixel SP2 can be supplied to each of the sub-pixels arranged in the same row as the second sub-pixel SP2.

As a result, the scan transistor SCT and the sensing transistor SENT of each of the sub-pixels arranged in the same row as the second sub-pixel SP2 can be turned on, as the second sub-pixel SP2. At this time, no current is generated to operate the light emitting device ED arranged in each of the sub-pixels arranged in the same row as the other second sub-pixels SP2. Therefore, during the sensing period of the second sub-pixel SP2, a horizontal line dimming phenomenon occurs in which a row where the second sub-pixel SP2 is arranged is processed as black, which can cause a deterioration in display quality.

Accordingly, the display device 100 according to the embodiments of the present disclosure can prevent the occurrence of a horizontal line dimming phenomenon by controlling the first emission control transistor ECT1 disposed in the sub-pixels located in the row where the second sub-pixel SP2 is disposed to be turned off during the sensing period of the second sub-pixel SP2, and controlling the second emission control transistor ECT2 disposed between the sub-pixels located in the row where the first sub-pixel SP1 is disposed and the sub-pixels located in the row where the second sub-pixel SP2 is disposed to be turned on.

Specifically, the display device 100 according to the embodiments of the present disclosure can supply a second emission control gate signal EM2 of a turn-on voltage level to the gate node of the second emission control transistor ECT2 during the sensing period of the second sub-pixel SP2, so that the second emission control transistor ECT2 can be turned on and current can be supplied from the second node N2 of the first sub-pixel SP1 in the light-emitting state to the second node N2 of the second sub-pixel SP2.

In this case, during the sensing period of the second sub-pixel SP2, the display device 100 according to the embodiments of the present disclosure can supply a first emission control gate signal EM1 at a turn-off voltage level to the gate node of the first emission control transistor ECT1 within the second sub-pixel SP2, thereby turning off the first emission control transistor ECT1 of the second sub-pixel SP2 and blocking the connection between the first node N1 and the second node N2 within the second sub-pixel SP2.

Through this, the display device 100 according to the embodiments of the present disclosure can control the second sub-pixel SP2 to emit light while sensing the characteristic value of the second sub-pixel SP2 during the sensing period of the second sub-pixel SP2, thereby preventing the occurrence of a horizontal line dimming phenomenon in the row in which the second sub-pixel SP2 is arranged during the sensing period of the second sub-pixel SP2.

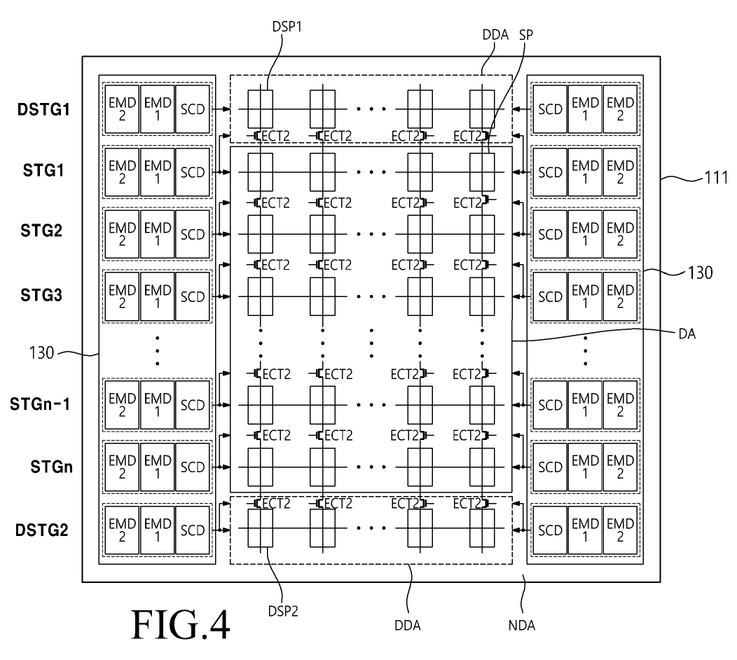

FIG. 4 illustrates an implementation example of a gate driving circuit 130 according to embodiments of the present disclosure.

Referring to FIG. 4, the gate driving circuit 130 can include a plurality of GIP circuits. The plurality of GIP circuits can be disposed in a non-display area NDA corresponding to each of the plurality of stages (e.g., STG, DSTG).

For example, the plurality of GIP circuits can include a GIP circuit disposed in a left non-display area NDA and a GIP circuit disposed in a right non-display area NDA with respect to the display area DA, corresponding to each of the plurality of stages STG and DSTG. However, embodiments of the present disclosure are not limited thereto, and the GIP circuits can be disposed only in a non-display area NDA corresponding to either the left or right side of the display area DA.

Each of the plurality of GIP circuits can include at least one of a scan driver SCD supplying a scan gate signal SCAN, a first emission control driver EMD1 supplying a first emission control gate signal EM1, and a second emission control driver EMD2 supplying a second emission control gate signal EM2.

According to the example of FIG. 4, the plurality of GIP circuits can include GIP circuits arranged in the first to n-th stages STG1 to STGn (wherein n is a positive integer), a GIP circuit arranged in a first dummy stage DSTG1 adjacent to the first stage STG1, and a GIP circuit arranged in a second dummy stage DSTG2 adjacent to the n-th dummy stage STGn.

In addition, the display device 100 can include a display area DA in which a plurality of sub-pixels SP are arranged, and at least one dummy display area DDA adjacent to the display area DA in which a plurality of dummy sub-pixels DSP1 and DSP2 are arranged.

According to the example of FIG. 4, the plurality of dummy sub-pixels can include a plurality of first dummy sub-pixels DSP1 arranged in an upper row of the first row, and a plurality of second dummy sub-pixels DSP2 arranged in a lower row of the n-th row.

For example, each of the plurality of first dummy sub-pixels DSP1 and the plurality of second dummy sub-pixels DSP2 can include a driving transistor DRT, a scan transistor SCT, aa sensing transistor SENT, a first emission control transistor ECT1, and a storage capacitor Cst illustrated in FIG. 2B.

In FIG. 4, for convenience of explanation, only one dummy stage DSTG1 and DSTG2 is illustrated in each of the upper region of the first stage STG1 and the lower region of the n-th stage STGn. However, the embodiments of the present disclosure are not limited thereto, and two or more dummy stages DSTG can be arranged in each of the upper region of the first stage STG1 and the lower region of the n-th stage STGn.

In this case, a plurality of first dummy sub-pixels DSP1 and a plurality of second dummy sub-pixels DSP2 can be arranged in two or more rows corresponding to each of two or more dummy stages DSTG in the dummy display area DDA.

According to the example of FIG. 4, the display device 100 according to the embodiments of the present disclosure can include a plurality of second emission control transistors ECT2, and each of the plurality of sub-pixels SP and the plurality of dummy sub-pixels DSP1 and DSP2 can be electrically connected to at least one of the plurality of second emission control transistors ECT2.

According to the examples of FIGS. 2A to 4, in the same column, the second emission control transistor ECT2 can be disposed between a second node N2 of the first dummy sub-pixel DSP1 and a second node N2 of the sub-pixel SP arranged in the first row, between a second node N2 of the sub-pixel SP arranged in the first row and a second node N2 of the sub-pixel SP arranged in the second row, and between a second node N2 of the sub-pixel SP arranged in the second row and a second node N2 of the sub-pixel SP arranged in the third row.

In addition, the second emission control transistor ECT2 can be disposed between a second node N2 of a sub-pixel SP disposed in the (n-2)-th row and a second node N2 of a sub-pixel SP disposed in the (n-1)-th row, between a second node N2 of a sub-pixel SP disposed in the (n-1)-th row and a second node N2 of a sub-pixel SP disposed in the n-th row, and between a second node N2 of a sub-pixel SP disposed in the n-th row and a second node N2 of the second dummy sub-pixel DSP2.

According to an embodiment of the present disclosure, in the display device 100 according to embodiments of the present disclosure, the second emission control transistor ECT2 may not be disposed between the sub-pixel disposed in the n-th row and the second dummy sub-pixel DSP2.

According to the example of FIG. 4, the scan driver SCD and the first emission control driver EMD1 arranged in the first stage STG1 can supply a scan gate signal SCAN and a first emission control gate signal EM1 to each of the sub-pixels SP arranged in the first row, the scan driver SCD and the first emission control driver EMD1 arranged in the second stage STG2 can supply a scan gate signal SCAN and a first emission control gate signal EM1 to each of the sub-pixels SP2 arranged in the second row, and the scan driver SCD and the first emission control driver EMD1 arranged in the third stage STG3 can supply a scan gate signal SCAN and a first emission control gate signal EM1 to each of the sub-pixels SP arranged in the third row.

In addition, the scan driver SCD and the first emission control driver EMD1 arranged in the (n-1)-th stage STGn-1 can supply a scan gate signal SCAN and a first emission control gate signal EM1 to each of the sub-pixels SP arranged in the (n-1)-th row, and the scan driver SCD and the first emission control driver EMD1 arranged in the n-th stage STGn can supply a scan gate signal SCAN and a first emission control gate signal EM1 to each of the sub-pixels SP arranged in the n-th row.

In addition, the scan driver SCD and the first emission control driver EMD1 arranged in the first dummy stage DSTG1 can supply a scan gate signal SCAN and a first emission control gate signal EM1 to a plurality of first dummy sub-pixels DSP1, and the scan driver SCD and the first emission control driver EMD1 arranged in the second dummy stage DSTG2 can supply a scan gate signal SCAN and a first emission control gate signal EM1 to a plurality of second dummy sub-pixels DSP2.

According to the example of FIG. 4, the second emission control driver EMD2 disposed in the first stage STG1 can supply the second emission control gate signal EM2 to each of the second emission control transistors ECT2 disposed between the first dummy sub-pixel DSP1 and the sub-pixel SP disposed in the first row, the second emission control driver EMD2 disposed in the second stage STG2 can supply the second emission control gate signal EM2 to each of the second emission control transistors ECT2 disposed between the sub-pixel SP disposed in the first row and the sub-pixel SP disposed in the second row, and the second emission control driver EMD2 disposed in the third stage STG3 can supply the second emission control gate signal EM2 to each of the second emission control transistors ECT2 disposed between the sub-pixel SP disposed in the second row and the sub-pixel SP disposed in the third row.

In addition, the second emission control driver EMD2 disposed in the (n-1)-th stage STGn-1 can supply a second emission control gate signal EM2 to each of the second emission control transistors ECT2 disposed between the sub-pixel SP disposed in the (n-2)-th row and the sub-pixel SP disposed in the (n-1)-th row, the second emission control driver EMD2 disposed in the n-th stage STGn can supply a second emission control gate signal EM2 to each of the second emission control transistors ECT2 disposed between the sub-pixel SP disposed in the (n-1)-th row and the sub-pixel SP disposed in the n-th row, and the second emission control driver EMD2 disposed in the second dummy stage DSTG2 can supply a second emission control gate signal EM2 to each of the second emission control transistors ECT2 disposed between the sub-pixel SP disposed in the n-th row and the second dummy sub-pixel DSP2.

According to an embodiment of the present disclosure, in the display device 100 according to embodiments of the present disclosure, a second emission control driver EMD2 may not be disposed in at least one of the first dummy stage DSTG1 and the second dummy stage DSTG2.

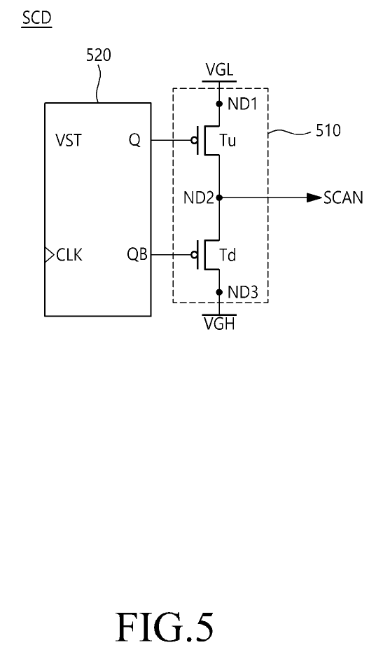

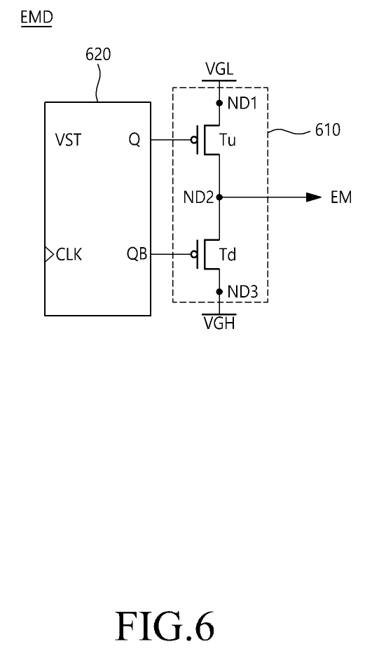

FIGS. 5 and 6 illustrate an implementation example of drivers (e.g., SCD, EMD1, and EMD2) in a gate driving circuit 130 according to embodiments of the present disclosure.

Specifically, FIG. 5 illustrates an example of a scan driver SCD included in a gate driving circuit 130 according to embodiments of the present disclosure, and FIG. 6 illustrates an example of an emission control driver EMD included in a gate driving circuit 130 according to embodiments of the present disclosure. Here, the emission control driver EMD can include at least one of a first emission control driver EMD1 and a second emission control driver EMD2.

Referring to FIGS. 5 and 6, the scan driver SCD and the emission control driver EMD can each include a buffer circuit 510 and 610, and a control circuit 520 and 620.

Each of the buffer circuits 510 and 610 can include a pull-up transistor Tu connected between a first node ND1 and a second node ND2 and a pull-down transistor Td connected between a third node ND3 and the second node ND2.

Each of the control circuits 520 and 620 can control the voltage of a first control node (i.e., Q node), which is a gate node of the pull-up transistor Tu, and a second control node (i.e., QB node), which is a gate node of the pull-down transistor Td.

Each of the buffer circuits 510 and 610 can output a gate signal to a gate line GL electrically connected to the second node ND2.

Specifically, the buffer circuit 510 of the scan driver SCD can output a scan gate signal SCAN, the buffer circuit 610 of the first emission control driver EMD1 can output a first emission control gate signal EM1, and the buffer circuit 610 of the second emission control driver EMD2 can output a second emission control gate signal EM2.

In each of the buffer circuits 510 and 610, a first power supply voltage can be applied to a first node ND1 and a second power supply voltage can be applied to a third node ND3. Here, one of the first power supply voltage and the second power supply voltage can be a gate high voltage VGH, and the other can be a gate low voltage VGL having a voltage level lower than the gate high voltage VGH.

According to the examples of FIGS. 5 and 6, the pull-up transistor Tu and the pull-down transistor Td provided in each of the buffer circuits 510 and 610 of the scan driver SCD and the emission control driver EMD can be p-type transistors.

If the pull-up transistor Tu and the pull-down transistor Td provided in each of the buffer circuits 510 and 610 are p-type transistors, the first power supply voltage can be a gate low voltage VGL and the second power supply voltage can be a gate high voltage VGH.

However, the embodiments of the present disclosure are not limited thereto, and the pull-up transistor Tu and the pull-down transistor Td provided in each of the buffer circuits 510 and 610 of the scan driver SCD and the emission control driver EMD can be designed as n-type transistors.

If the pull-up transistor Tu and the pull-down transistor Td provided in each of the buffer circuits 510 and 610 are n-type transistors, the first power supply voltage can be a gate high voltage VGH and the second power supply voltage can be a gate low voltage VGL.

According to an embodiment of the present disclosure, the buffer circuit 510 of the scan driver SCD and the buffer circuit 610 of the emission control driver EMD can each be supplied with a first power supply voltage and a second power supply voltage of different voltage levels.

For example, the buffer circuit 510 of the scan driver SCD can output a scan gate signal SCAN based on a first gate high voltage and a first gate low voltage, and the buffer circuit 610 of the emission control driver EMD can output an emission control gate signal EM based on a second gate high voltage and a second gate low voltage.

According to the examples of FIGS. 5 and 6, the scan driver SCD and the emission control driver EMD can be supplied with a start signal VST and a clock signal CLK corresponding to each driver from the controller 140, and a gate high voltage VGH and a gate low voltage VGL can be supplied to each of a pull-up transistor Tu that is turned on or off according to the voltage of the Q node and a pull-down transistor Td that is turned on or off according to the voltage of the QB node from the power management integrated circuit, thereby outputting a scan gate signal SCAN and an emission control gate signal EM, respectively.

For example, the clock signals CLK supplied to each of the scan driver SCD, the first emission control driver EMD1, and the second emission control driver EMD2 can be the same signals.

Alternatively, at least two clock signals CLK supplied to each of the scan driver SCD, the first emission control driver EMD1 and the second emission control driver EMD2 can be different signals.

For example, the scan driver SCD can receive a first clock signal, the first emission control driver EMD1 can receive a second clock signal, and the second emission control driver EMD2 can receive a third clock signal. Here, at least two of the first to third clock signals can be different signals.

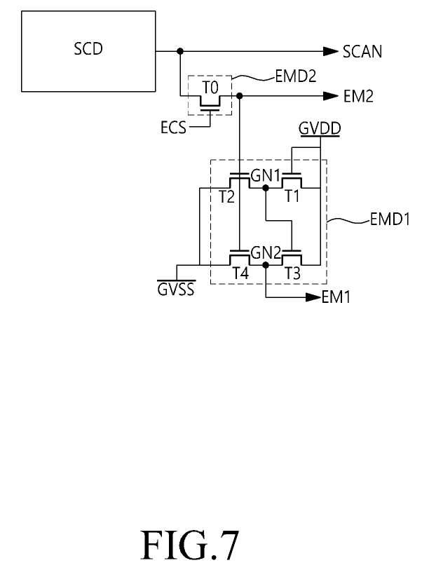

FIG. 7 is a diagram for explaining another implementation example of the drivers SCD, EMD1, and EMD2 in the gate driving circuit 130 according to embodiments of the present disclosure.

Referring to FIG. 7, the scan driver SCD can output a scan gate signal SCAN, the second emission control driver EMD2 can output a second emission control gate signal EM2 corresponding to the scan gate signal SCAN, and the first emission control driver EMD1 can output a first emission control gate signal EM1 corresponding to the second emission control gate signal EM2.

Hereinafter, for convenience of explanation, the scan driver SCD, the first emission control driver EMD1, and the second emission control driver EMD2 of FIG. 7 will be described as drivers arranged in the second stage STG2 disclosed in FIG. 4.

However, the embodiments of the present disclosure are not limited thereto, and the scan driver SCD, the first emission control driver EMD1, and the second emission control driver EMD2 of FIG. 7 can be drivers arranged in at least one of the first to n-th stages STG1 to STGn, the first dummy stage DSTG1, and the second dummy stage DSTG2.

If the scan driver SCD, the first emission control driver EMD1, and the second emission control driver EMD2 of FIG. 7 are arranged in the second stage STG2, the scan driver SCD can supply a scan gate signal SCAN to a gate node of at least one of the scan transistor SCT and the sensing transistor SENT arranged in the second sub-pixel SP2.

In addition, the second emission control driver EMD2 can supply a second emission control gate signal EM2 to a gate node of the second emission control transistor ECT2 arranged between a sub-pixel SP arranged in the first row and a sub-pixel SP arranged in the second row.

In addition, the first emission control driver EMD1 can supply a first emission control gate signal EM1 to a gate node of the first emission control transistor ECT1 arranged in the second sub-pixel SP2.

For example, the scan driver SCD of FIG. 7 can be a scan driver according to an embodiment disclosed in FIG. 5, but embodiments of the present disclosure are not limited thereto.

According to the example of FIG. 7, the second emission control driver EMD2 can be positioned between an output terminal of the scan driver SCD and an input terminal of the second emission control driver EMD2, and can include a transistor T0 whose switching operation is controlled based on a switching control signal ECS supplied through a gate node.

In FIG. 7, the transistor T0 in the second emission control driver EMD2 is illustrated as an n-type transistor, but embodiments of the present disclosure are not limited thereto, and the transistor T0 in the second emission control driver EMD2 can be a p-type transistor.

For example, the controller 140 can supply a switching control signal ECS of a turn-on voltage level to the transistor T0 in the second emission control driver EMD2 during a sensing period of the second sub-pixel SP2, and accordingly, the transistor T0 can be turned on during the sensing period of the second sub-pixel SP2 and supply a second emission control gate signal EM2 of the same voltage level as the scan gate signal SCAN.

For a more specific example, during the sensing period of the sub-pixel SP arranged in the second row, the scan gate driver SCAN can supply a scan gate signal SCAN at a turn-on voltage level to the sub-pixel SP arranged in the second row, and the second emission control driver EMD2 can supply a second emission control gate signal EM2 at a turn-on voltage level to the second emission control transistor ECT2 arranged between the sub-pixel SP arranged in the first row and the sub-pixel SP arranged in the second row.

The first emission control driver EMD1 can supply a first emission control gate signal EM1 at a low voltage level when the second emission control gate signal EM2 is at a high voltage level, and can supply a first emission control gate signal EM1 at a high voltage level when the second emission control gate signal EM2 is at a low voltage level.

For example, the first emission control driver EMD1 can supply the first emission control gate signal EM1 having a voltage level different from the voltage level of the second emission control gate signal EM2.

For example, assuming that the second sub-pixel SP2 of FIG. 3 is one of the sub-pixels SP arranged in the second row, during the sensing period of the second sub-pixel SP2, the second emission control driver EMD2 can supply a second emission control gate signal EM2 at a turn-on voltage level (e.g., a high voltage level) to the second emission control transistor ECT2 arranged between the sub-pixel SP arranged in the first row and the sub-pixel SP arranged in the second row, and the first emission control driver EMD1 can supply a first emission control gate signal EM2 at a turn-off voltage level (e.g., a low voltage level) to the first emission control transistor ECT1 in the sub-pixel SP arranged in the second row.

To this end, the first emission control driver EMD1 can include first to fourth gate transistors T1 to T4.

The first gate transistor T1 can be electrically connected to a high-potential gate voltage line that supplies a high-potential gate voltage GVDD.

The first gate transistor T1 can be a diode-connected transistor. For example, the first gate transistor T1 can have a gate node and a drain node electrically connected to the high-potential gate voltage line.

The second gate transistor T2 can be electrically connected to a low-potential gate voltage line that supplies a low-potential gate voltage GVSS and an intermediate node GN1 to which the first gate transistor T1 is connected.

The second gate transistor T2 can be electrically connected to an output terminal of the second emission control driver EMD2 via a gate node, so that a switching operation can be controlled according to a second emission control gate signal EM2 output from the second emission control driver EMD2.

The third gate transistor T3 can be electrically connected to a high-potential gate voltage line and an output node GN2 from which the first emission control gate signal EM1 is output.

The third gate transistor T3 can be electrically connected to an intermediate node GN1 via a gate node, so that a switching operation can be controlled according to the voltage level of the intermediate node GN1.

The fourth gate transistor T4 can be electrically connected to a low-potential voltage line and an output node GN2.

The fourth gate transistor T4 can be electrically connected to the output terminal of the second emission control driver EMD2 through the gate node, so that the switching operation can be controlled according to the second emission control gate signal EM2 output from the second emission control driver EMD2.

If the second emission control gate signal EM2 is at a high voltage level, the first emission control driver EMD1 can supply the first emission control gate signal EM1 at a low voltage level by turning on the first gate transistor T1, the second gate transistor T2, and the fourth gate transistor T4, and turning off the third gate transistor T3.

If the second emission control gate signal EM2 is at a low voltage level, the first emission control driver EMD1 can supply the first emission control gate signal EM1 at a high voltage level by turning on the first gate transistor T1 and the third gate transistor T3, and turning off the second gate transistor T2 and the fourth gate transistor T4.

In FIG. 7, the first to fourth gate transistors T1 to T4 in the first emission control driver EMD1 are exemplified as n-type transistors, but the embodiments of the present disclosure are not limited thereto, and at least one of the first to fourth gate transistors T1 to T4 can be a p-type transistor.

Embodiments of the present disclosure described above are briefly described as follows.

A display device according to embodiments of the present disclosure can include a display panel in which a plurality of sub-pixels each of which having a driving transistor, a light emitting device, and a first emission control transistor disposed between the driving transistor and the light emitting device, a plurality of gate lines, and a plurality of data lines are disposed, a gate driving circuit configured to drive the plurality of gate lines, and a data driving circuit configured to supply a data voltage to the plurality of data lines, wherein at least one of the plurality of sub-pixels is electrically connected to at least one adjacent sub-pixel connected to the same data line through a second emission control transistor, wherein the first emission control transistor is disposed between a first node to which the driving transistor is electrically connected and a second node to which the second emission control transistor and the light emitting device are electrically connected.

The plurality of sub-pixels can include a first sub-pixel and a second sub-pixel electrically connected to the first sub-pixel through the second emission control transistor.

The gate driving circuit can supply a first emission control gate signal having a turn-on voltage level to a gate node of the first emission control transistor disposed in the first sub-pixel during a sensing period of the second sub-pixel.

The gate driving circuit can supply a first emission control gate signal having a turn-off voltage level to a gate node of the first emission control transistor disposed in the second sub-pixel during a sensing period of the second sub-pixel.

The gate driving circuit can supply a second emission control gate signal having a turn-on voltage level to a gate node of the second emission control transistor during a sensing period of the second sub-pixel.

Each of the plurality of sub-pixels can further include a scan transistor disposed between a corresponding one of the plurality of data lines and a gate node of the driving transistor, and a sensing transistor disposed between the first node and a sensing line.

A switching operation of the scan transistor and the sensing transistor can be controlled by a scan gate signal.

The gate driving circuit can include a scan driver that supplies a scan gate signal to a gate node of at least one of a scan transistor disposed in the second sub-pixel and a sensing transistors disposed in the second sub-pixel, a second emission control driver that supplies a second emission control gate signal corresponding to the scan gate signal to a gate node of the second emission control transistor, and a first emission control driver that supplies a first emission control gate signal corresponding to the second emission control gate signal to a gate node of the first emission control transistor disposed in the second sub-pixel.

The second emission control driver can include a transistor located between an output terminal of the scan driver and an input terminal of the second emission control driver, and whose switching operation is controlled based on a switching control signal supplied through a gate node.

The second emission control driver can supply the second emission control gate signal having a turn-on voltage level if the scan gate signal has a turn-on voltage level.

The first emission control driver can supply the first emission control gate signal at a low voltage level if the second emission control gate signal is at a high voltage level, and can supply the first emission control gate signal at a high voltage level if the second emission control gate signal is at a low voltage level.

The first emission control driver can include a first gate transistor electrically connected to a high-potential gate voltage line, a second gate transistor electrically connected to a low-potential gate voltage line and an intermediate node to which the first gate transistor is connected, a third gate transistor electrically connected to the high-potential gate voltage line and an output node from which the first emission control gate signal is output, and electrically connected to the intermediate node through a gate node, and a fourth gate transistor electrically connected to the low-potential gate voltage line and the output node.

The second gate transistor and the fourth gate transistor can be electrically connected to an output terminal of the second emission control driver through a gate node.

The first gate transistor can be a diode-connected transistor whose gate node is connected to the high-potential gate voltage line.

A gate driving circuit according to embodiments of the present disclosure can include a scan driver that supplies a scan gate signal to a second sub-pixel adjacent to a first sub-pixel, connected to the same data line as the first sub-pixel, and electrically connected to the first sub-pixel through a second emission control transistor, a second emission control driver that supplies a second emission control gate signal to a gate node of the second emission control transistor, and a first emission control driver that supplies a first emission control gate signal corresponding to the second emission control gate signal to a first emission control transistor disposed in the second sub-pixel, wherein the first emission control transistor is disposed between a first node to which a driving transistor is electrically connected and a second node to which the second emission control transistor and a light emitting device are electrically connected, and receives the second emission control gate signal through a gate node.

The above description has been presented to enable any person skilled in the art to make and use the technical idea of the present invention, and has been provided in the context of a particular application and its requirements. Various modifications, additions and substitutions to the described

embodiments will be readily apparent to those skilled in the art, and the general principles defined herein can be applied to other embodiments and applications without departing from the spirit and scope of the present invention. The above description and the accompanying drawings provide an example of the technical idea of the present invention for illustrative purposes only. For example, the disclosed embodiments are intended to illustrate the scope of the technical idea of the present invention.

What is claimed is:

1. A display device comprising:
a display panel including a plurality of sub-pixels, a plurality of gate lines, and a plurality of data lines, each of the plurality of sub-pixels having a driving transistor, a light emitting device, and a first emission control transistor disposed between the driving transistor and the light emitting device;
a gate driving circuit configured to drive the plurality of gate lines; and
a data driving circuit configured to supply a data voltage to the plurality of data lines,
wherein at least one of the plurality of sub-pixels is electrically connected to at least one adjacent sub-pixel connected to the same data line through a second emission control transistor, and
wherein for one of the plurality of sub-pixels, the first emission control transistor is disposed between a first node to which the driving transistor is electrically connected and a second node to which the second emission control transistor and the light emitting device are electrically connected.

2. The display device of claim 1, wherein the plurality of sub-pixels include a first sub-pixel and a second sub-pixel electrically connected to the first sub-pixel through the second emission control transistor.

3. The display device of claim 2, wherein the gate driving circuit supplies a first emission control gate signal having a turn-on voltage level to a gate node of the first emission control transistor disposed in the first sub-pixel during a sensing period of the second sub-pixel.

4. The display device of claim 2, wherein the gate driving circuit supplies a first emission control gate signal having a turn-off voltage level to a gate node of the first emission control transistor disposed in the second sub-pixel during a sensing period of the second sub-pixel.

5. The display device of claim 2, wherein the gate driving circuit supplies a second emission control gate signal having a turn-on voltage level to a gate node of the second emission control transistor during a sensing period of the second sub-pixel.

6. The display device of claim 1, wherein each of the plurality of sub-pixels further includes:
a scan transistor disposed between a corresponding one of the plurality of data lines and a gate node of the driving transistor; and
a sensing transistor disposed between the first node and a sensing line.

7. The display device of claim 6, wherein a switching operation of the scan transistor and the sensing transistor is controlled by a scan gate signal.

8. The display device of claim 2, wherein the gate driving circuit includes:
a scan driver configured to supply a scan gate signal to a gate node of at least one of a scan transistor disposed in the second sub-pixel and a sensing transistor disposed in the second sub-pixel.

9. The display device of claim 8, wherein the gate driving circuit further includes:
a second emission control driver configured to supply a second emission control gate signal corresponding to the scan gate signal to a gate node of the second emission control transistor; and
a first emission control driver configured to supply a first emission control gate signal corresponding to the second emission control gate signal to a gate node of the first emission control transistor disposed in the second sub-pixel.

10. The display device of claim 9, wherein the second emission control driver includes a transistor located between an output terminal of the scan driver and an input terminal of the second emission control driver, and
wherein a switching operation of the transistor included in the second emission control driver is controlled based on a switching control signal supplied through a gate node.

11. The display device of claim 9, wherein the second emission control driver supplies the second emission control gate signal having a turn-on voltage level when the scan gate signal has a turn-on voltage level.

12. The display device of claim 9, wherein the first emission control driver supplies the first emission control gate signal at a low voltage level when the second emission control gate signal is at a high voltage level.

13. The display device of claim 12, wherein the first emission control driver supplies the first emission control gate signal at a high voltage level when the second emission control gate signal is at a low voltage level.

14. The display device of claim 9, wherein the first emission control driver includes:
a first gate transistor electrically connected to a high-potential gate voltage line; and
a second gate transistor electrically connected to a low-potential gate voltage line and an intermediate node to which the first gate transistor is connected.

15. The display device of claim 14, wherein the first emission control driver further includes:
a third gate transistor electrically connected to the high-potential gate voltage line and an output node from which the first emission control gate signal is output, and electrically connected to the intermediate node through a gate node; and
a fourth gate transistor electrically connected to the low-potential gate voltage line and the output node.

16. The display device of claim 15, wherein the second gate transistor and the fourth gate transistor are electrically connected to an output terminal of the second emission control driver through a gate node.

17. The display device of claim 14, wherein the first gate transistor is a diode-connected transistor whose gate node is connected to the high-potential gate voltage line.

18. A gate driving circuit comprising:
a scan driver configured to supply a scan gate signal to a second sub-pixel adjacent to a first sub-pixel, connected to a same data line as the first sub-pixel, and electrically connected to the first sub-pixel through a second emission control transistor;
a second emission control driver configured to supply a second emission control gate signal to a gate node of the second emission control transistor; and
a first emission control driver configured to supply a first emission control gate signal corresponding to the second emission control gate signal to a first emission control transistor disposed in the second sub-pixel,
wherein the first emission control transistor is disposed between a first node to which a driving transistor is electrically connected and a second node to which the second emission control transistor and a light emitting device are electrically connected, and
wherein the first emission control transistor receives the second emission control gate signal through a gate node.

19. The gate driving circuit of claim 18, wherein the first emission control driver includes:
a first gate transistor electrically connected to a high-potential gate voltage line; and
a second gate transistor electrically connected to a low-potential gate voltage line and an intermediate node to which the first gate transistor is connected.

20. The gate driving circuit of claim 19, wherein the first emission control driver further includes:
a third gate transistor electrically connected to the high-potential gate voltage line and an output node from which the first emission control gate signal is output; and
a fourth gate transistor electrically connected to the low-potential gate voltage line and the output node.
